(19) United States
(12) Patent Application Publication
(10) Pub. No.: US 2009/0319686 A1
(43) Pub. Date: Dec. 24, 2009

(54) COMMUNICATION ROUTE SELECTING METHOD AND APPARATUS

(75) Inventor: Kazuhiro Watanabe, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/552,773

(22) Filed: Sep. 2, 2009

Related U.S. Application Data
(63) Continuation of application No. PCT/JP2007/056489, filed on Mar. 27, 2007.

(51) Int. Cl. G06F 15/173; G06F 15/16

(52) U.S. Cl. 709/240; 709/206

(57) ABSTRACT

A computer readable storage medium contains instructions that, when executed by a computer, cause the computer to perform: measuring a transmission time period taken to transmit a message for each of a plurality of communication routes by exchanging a control message via the plurality of communication routes; determining a priority of each of the plurality of communication routes based on the measured transmission time period; and if a priority has been set to a message to be exchanged between communication apparatuses connected via the plurality of communication routes, selecting one of the plurality of communication routes, as a route to transmit the message based on the set priority and the determined priority.

### CROSS-REFERENCE TO RELATED APPLICATION(S)

This application is a continuation of PCT international application Ser. No. PCT/JP2007/056489 filed on Mar. 27, 2007 which designates the United States, the entire contents of which are incorporated herein by reference.

### FIELD

The embodiments discussed herein are directed to a communication route selecting program, a communication route selecting method, and a communication route selecting apparatus for selecting a communication route for transmitting a message exchanged between communication apparatuses connected via a plurality of communication routes.

### BACKGROUND

With the recent increase in corporate mergers and reorganizations, the service-oriented architecture (SOA) has attracted attention as a technology to allow the systems between and within the corporations to cooperate with each other. The SOA enables architecture of a system by allowing “services” to cooperate with each other over a network. The “service” herein means a group of software functions that has been grouped together per business transaction or process.

The SOA uses the enterprise service bus (ESB) to connect services. The ESB has a function of routing a message exchanged between the services, and a function of converting a message protocol and a data format in accordance with a destination system. To achieve compatibility between interfaces of the services, specifications of the Web service are introduced.

The Web service allows the services to be read out by using the mechanism of the Web. The Web service uses the simple object access protocol (SOAP) as a communication protocol and the Web services description language (WSDL) as a description language. The SOAP is a standard for performing communications by exchanging extensible-markup-language based (XML-based) messages, and the WSDL is an XML-based language defining a method of describing information for accessing the Web service.

A single ESB may be connected to a plurality of services. Further, a plurality of ESBs may be connected over a network to enable services connected to different ESBs to cooperate with each other. When a plurality of ESBs are used, a message exchanged between the services is transferred from a source service to a destination service via the plurality of ESBs. Therefore, there are different possible combinations of ESBs via which the message is routed to reach the same destination service. In other words, even if the destination service is the same, there are different communication routes via which a message is transmitted.

However, if each network connecting the ESBs has a different bandwidth, the message may stay in the ESB connected to a network with a narrow bandwidth. FIG. 22 is an illustrative diagram of a conventional message transfer. In FIG. 22, an ESB relay node (a communication apparatus having functions of the ESB) Ea connected to a service Sa, an ESB relay node Eb connected to a service Sb, an ESB relay node Ec connected to a service Sc, and an ESB relay node Ed connected to a service Sd are connected over networks.

It is assumed herein that the same bandwidth is set to the network between the ESB relay nodes Ea and Eb, the network between the ESB relay nodes Eb and Ec, and the network between the ESB relay nodes Ea and Ed, and a half of this bandwidth between these ESB relay nodes is set to the network between the ESB relay nodes Ec and Ed.

If a message is transmitted from the service Sa to the service Sc, the ESB relay node Ea normally allots the message to the ESB relay nodes Eb and Ed equally based on information such as quality of service (QoS).

However, because the bandwidth set for the network between the relay nodes Ec and Ed is half the bandwidth between the relay nodes Eb and Ec, the message stays at the ESB relay node Ed.

To resolve such bottleneck due to the difference in the bandwidths, a method has been proposed in which a time period taken to transmit a message over each communication route is measured by exchanging a control message over a plurality of communication routes to be used for transmitting messages, and a route to be used to transmit a message is selected based on the measured time period (see e.g. Japanese Laid-open Patent Publication No. 06-120944 and Japanese Laid-open Patent Publication No. 11-168505).

Items that are set in a message exchanged between services differ among different services. Depending on a type of a service, a priority of a business transaction may be set for a message.

However, because in the above conventional method the communication route is merely selected based on the time period measured for each communication route, every message is transmitted via the same communication route regardless of the priority of the message. Therefore, the conventional method does not allow business transactions to be executed based on their priorities.

### SUMMARY

According to an aspect of the invention, a computer readable storage medium contains instructions that, when executed by a computer, cause the computer to perform: measuring a transmission time period taken to transmit a message for each of a plurality of communication routes by exchanging a control message via the plurality of communication routes; determining a priority of each of the plurality of communication routes based on the measured transmission time period; and if a priority has been set to a message to be exchanged between communication apparatuses connected via the plurality of communication routes, selecting one of the plurality of communication routes, as a route to transmit the message based on the set priority and the determined priority.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram of a configuration of a distributed system according to an embodiment of the present invention;

FIG. 2 is a first illustrative diagram of a concept of a communication route selecting method according to the embodiment;

FIG. 3 is a second illustrative diagram of the concept of the communication route selecting method according to the embodiment;

FIG. 4 is a functional block diagram of a configuration of an ESB relay node according to the embodiment;

FIG. 5 is a diagram of an example of set information stored in a set information storage unit;

FIG. 6 is a diagram of an example of a Google Sitemap message;

FIG. 7 is a diagram of an example of a message according to the OASIS PPS Part 1 “Core Element” specification;

FIG. 8 is a diagram of an example of service information stored in a service information table;

FIG. 9 is a diagram of an example of priority control policy information stored in a priority control policy table;

FIG. 10 is a diagram of an example of a route search control message used in a route searching process;

FIG. 11 is a first diagram of an example of the route search control message used when a proxy response is carried out during transfer;

FIG. 12 is a second diagram of an example of the route search control message used when the proxy response is carried out during transfer;

FIG. 13 is a diagram of an example of route control information stored in a route control table;

FIG. 14 is a diagram of an example of bandwidth control information stored in a bandwidth control table;

FIG. 15 is a flowchart indicating procedural steps of a service information generating process performed by a service managing unit;

FIG. 16 is a flowchart indicating procedural steps of a route searching process performed by a route analyzing unit;

FIG. 17 is a flowchart indicating procedural steps of a bandwidth control information updating process performed by the route analyzing unit;

FIG. 18 is a first flowchart indicating procedural steps of a message transfer route selecting process performed by a service accessing unit;

FIG. 19 is a second flowchart indicating procedural steps of the message transfer route selecting process performed by the service accessing unit;

FIG. 20 is a third flowchart indicating procedural steps of the message transfer route selecting process performed by the service accessing unit;

FIG. 21 is a functional block diagram of a configuration of a computer executing a communication route selecting program according to the embodiment; and

FIG. 22 is an illustrative diagram of a conventional message transfer.

### DESCRIPTION OF EMBODIMENTS

Embodiments of a communication route selecting program, a communication route selecting method, and a communication route selecting apparatus according to the present invention will now be explained in detail with reference to the accompanying drawings. The embodiments in which the present invention is applied to a distributed system arranged according to the SOA will be explained. However, the present invention is not limited by these embodiments.

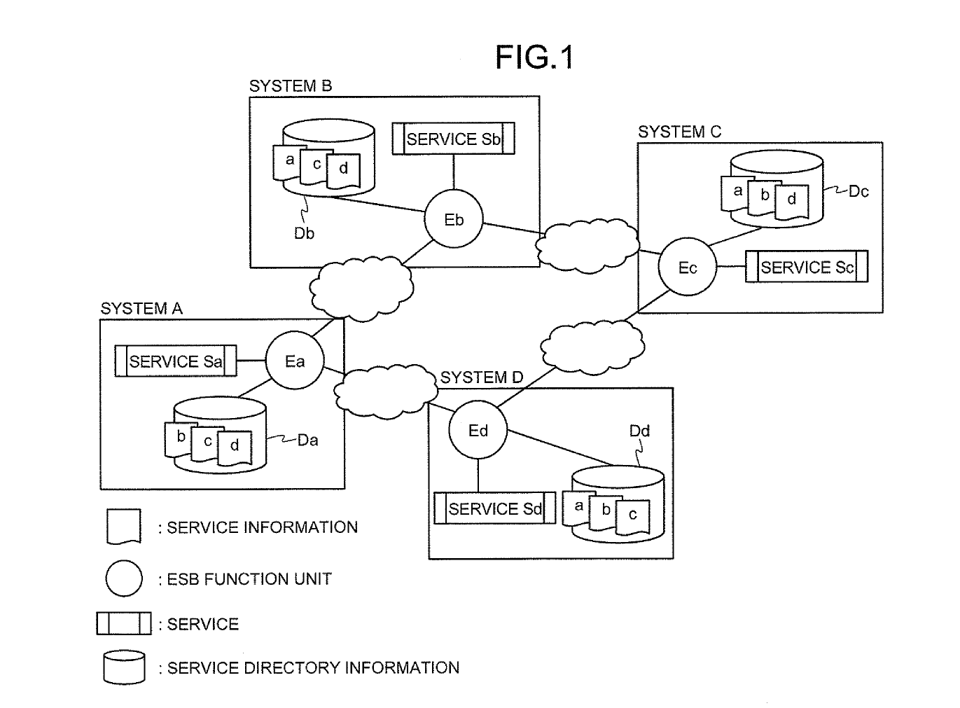

A configuration of the distributed system according to an embodiment will be explained. FIG. 1 is a diagram of the configuration of the distributed system. As depicted in FIG. 1, the distributed system includes a system A that provides a service Sa, a system B that provides a service Sb, a system C that provides a service Sc, and a system D that provides a service Sd.

The system A includes the service Sa, an ESB relay node Ea, and service directory information Da connected over a network. The service Sa is realized by a predetermined application, and the ESB relay node Ea transfers a message exchanged between services.

The service directory information Da includes service information set for each service. The service information includes a service name and a uniform resource identifiers (URI), which are required to access the other services (the services Sb, Sc, and Sd in this example) connectable via a network. Each service information included in the service directory information Da, is described in the WSDL, for example, and used when the service Sa calls for the other services.

In a similar manner, the system B includes the service Sb, an ESB relay node Eb, and service directory information Db connected to each other; the system C includes the service Sc, an ESB relay node Ec, and service directory information Dc connected to each other; and the system D includes the service Sd, an ESB relay node Ed, and service directory information Dd connected to each other.

These systems are further connected via networks, with each of their ESB relay nodes functioning as a relay point. More specifically, the ESB relay nodes Ea and Eb are connected to each other via a network, the ESB relay nodes Eb and Ec are connected to each other via a network, the ESB relay nodes Ec and Ed are connected to each other via a network, and the ESB relay nodes Ea and Ed are connected to each other via a network.

Accordingly, when a message is to be sent from the service Sa to the service Sc, the service Sa transmits the message to the ESB relay node Ea, and the ESB relay node Ea transfers the message to the ESB relay node Eb or Ed. The ESB relay node Eb or Ed that receives the message further transfers the message to the ESB relay node Ec. The ESB relay node Ec then transfers the message to the service Sc.

In other words, when a message is to be sent from the service Sa to the service Sc, either one of a route via the ESB relay nodes Ea, Eb, and Ec in this sequence or a route via the ESB relay nodes Ea, Ed, and Ec in this sequence is used.

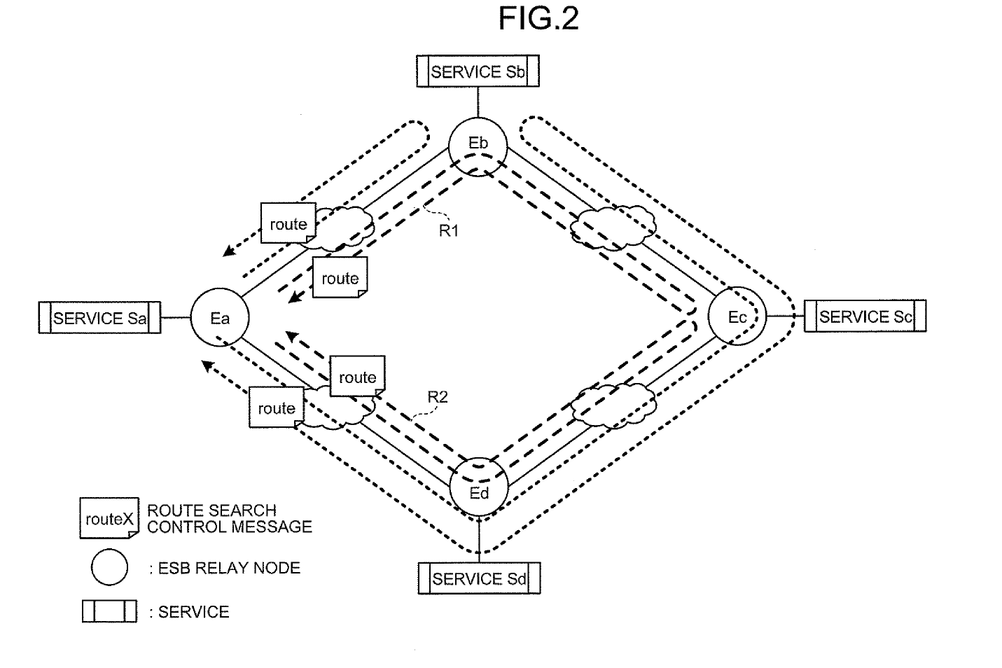

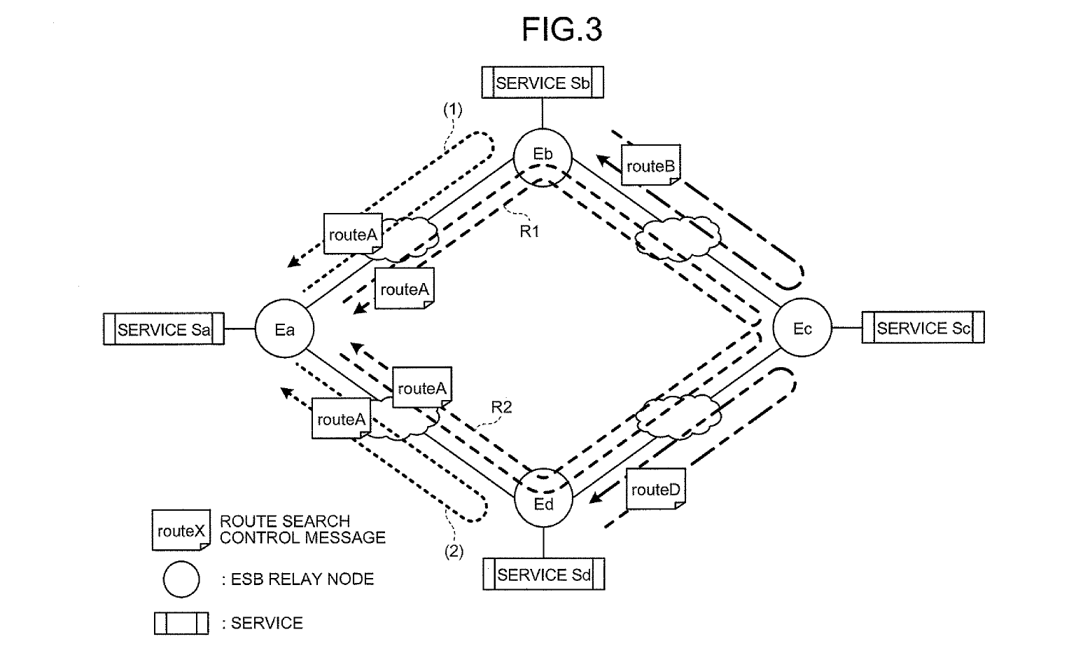

A concept of the communication route selecting method according to the embodiment will now be explained. FIGS. 2 and 3 are illustrative diagrams of the concept of the communication route selecting method according to the embodiment. In these diagrams, the systems A to D and the service directory information Da to Dd included in the distributed system depicted in FIG. 1 are omitted for the convenience of explanation.

In the communication route selecting method according to the embodiment, each of the ESB relay nodes Ea to Ed measures a transmission time period taken to transmit a message to each of the services Sa to Sd other than the service accommodated in the same system as that ESB relay node measuring the time period, for each route reachable to the each of the services Sa to Sd other than that service. This process is hereinafter referred to as a “route searching process”.

More specifically, each of the ESB relay nodes Ea to Ed periodically transmits a control message addressed to each of the services Sa to Sd excluding the service accommodated in the same system as itself, over all of the communication routes reachable to the destination service. Each of the ESB relay nodes Ea to Ed sends this control message to collect route information. The route information is used for calculating the transmission time period for the message over each of the communication routes. This control message is hereinafter referred to as a “route search control message”. The route search control message corresponds to a “transmission time period measuring message” mentioned in the claims.

The ESB relay node then calculates the message transmission time period for each of the communication routes based on the collected route information, and determines a priority of each of the communication routes in ascending order of the transfer time period. This priority set for each of the communication routes is hereinafter referred to as “route priority”.

The route searching process will now be explained more specifically with reference to FIG. 2. In this example, the ESB relay node Ea sends a route search control message addressed to the service Sc. In FIG. 2, two communication routes are available for transmitting a message: a route R1 via the ESB relay nodes Ea, Eb, and Ec in this order; and a route R2 via the ESB relay nodes Ea, Ed, and Ec in this order.

The ESB relay node Ea sends a route search control message (request) addressed to the URI of the service Sc. Upon this sending, the ESB relay node Ea sends the route search control message (request) to all ESB relay nodes connected to the ESB relay node Ea. More specifically, the ESB relay node Ea sends the route search control message (request) to each of the ESB relay nodes Eb and Ed.

When the ESB relay node Eb receives the route search control message (request) addressed to the URI of the service Sc, because the addressed service Sc is not accommodated in the same system as the ESB relay node Eb, the ESB relay node Eb inserts information indicating the ESB relay node Eb and a time stamp to the received message, and transfers the message via an interface other than the one through which the message has been received. More specifically, the ESB relay node Eb transfers the route search control message (request) to the ESB relay node Ec.

The ESB relay node Ed also performs a process similar to that performed by the ESB relay node Eb, upon receiving the route search control message (request) addressed to the URI of the service Sc. More specifically, the ESB relay node Ed transfers the route search control message (request) to the ESB relay node Ec.

When the ESB relay node Ec receives the route search control message (request) transferred from the ESB relay node Eb, because the destination service Sc is accommodated in the same system as the ESB relay node Ec, the ESB relay node Ec inserts information indicating the ESB relay node Ec and a time stamp, changes the destination to the ESB relay node Ea and a message type to a route search control message (response), and returns the message via the interface through which the message has been received. More specifically, the ESB relay node Ec returns the route search control message (response) addressed to the ESB relay node Eb.

Upon receiving the route search control message (request) transferred from the ESB relay node Ed, the ESB relay node Ec performs a process similar to that performed upon receiving the route search control message (request) transferred from the ESB relay node Eb. More specifically, the ESB relay node Ec returns the route search control message (response) to the ESB relay node Ed.

Upon receiving the route search control message (response) addressed to the ESB relay node Ea transferred from the ESB relay node Ec, because the destination of the received message is not the ESB relay node Eb, the ESB relay node Eb inserts information indicating the ESB relay node Eb and a time stamp, and transfers the message to the interface through which the route search control message (request) has been received. More specifically, the ESB relay node Eb transfers the route search control message (response) to the ESB relay node Ea.

Upon receiving the route search control message (response) addressed to the ESB relay node Ea transferred from the ESB relay node Ec, the ESB relay node Ed performs a process similar to that performed by the ESB relay node Eb. More specifically, the ESB relay node Ed transfers the route search control message (response) to the ESB relay node Ea.

Upon receiving the route search control messages (response) addressed to the ESB relay node Ea from the ESB relay nodes Eb and Ed, the ESB relay node Ea calculates the transmission time periods taken to transmit the messages over the communication routes via which these messages have been transferred, based on the information included in the received messages. The ESB relay node Ea then sets a route priority to each of the communication routes based on the calculated transfer time periods.

Each of the ESB relay nodes Ea to Ed holds the transmission time period and the route priority for all the communication routes reachable to all the services Sa to Sd excluding the service accommodated in the same system as itself. Each of the ESB relay nodes Ea to Ed performs the route searching process periodically, and updates the transmission time period and the route priority of each of the communication routes based on information included in a route search control message (response) every time the route searching process is performed. In this manner, the transmission time period and the route priority for each of the communication routes are dynamically changed in accordance with states of the networks and ESB relay nodes Ea to Ed.

When a message exchanged between the services is received, each of the ESB relay nodes Ea to Ed checks a message priority of the message to select a communication route to be used to transmit the message. If the message priority is high, the each of the ESB relay nodes Ea to Ed transfers the message via the communication route having a high route priority set in the route searching process. If the message priority is low, the message is transferred via the communication route having a low route priority.

In this manner, in the communication route selecting method according to the embodiment, it is possible to select the optimum communication route in accordance with a message priority of a message.

In the description above, each of the ESB relay nodes Ea to Ed sends a single route search control message over each of the communication routes. However, a message priority may be set to each route search control message, and a plurality of route search control messages each having a different priority may be transmitted via a single communication route, so as to measure transmission time periods dependent on the message priorities. As a result, it is possible to select a more appropriate communication route depending on a message priority of a message.

In this route searching process, because each of the ESB relay nodes Ea to Ed periodically sends multiple route search control messages, these messages may increase loads on the networks connecting the ESB relay nodes Ea to Ed.

Therefore, in the communication route selecting method according to the embodiment, the ESB relay nodes Ea to Ed each store the route information including the transmission time period measured in the route searching process for each communication route. When an ESB relay node receives a route search control message (request), the ESB relay node determines whether the route information of the communication route to the service set as a destination of the message is included in the stored route information. If it is included, the ESB relay node acts as a proxy to return a route search control message (response) including the route information. Accordingly, transfer of the route search control message (request) to the service that has been set as the destination may be omitted to reduce the load on the network.

This proxy response will now be explained more specifically with reference to FIG. 3. In FIG. 3, similarly to FIG. 2, the ESB relay node Ea sends a route search control message addressed to the service Sc. In FIG. 3, the ESB relay nodes Eb and Ed each already hold route information to the service Sc.

First, the ESB relay node Ea sends the route search control message (request) to the URI of the service Sc. Here, the ESB relay node Ea sends the route search control message (request) to all of the ESB relay nodes connected to the ESB relay node Ea. More specifically, the ESB relay node Ea sends the route search control message (request) to each of the ESB relay nodes Eb and Ed.

The ESB relay node Eb receives the route search control message (request) addressed to the URI of the service Sc. Because the destination service Sc is not accommodated in the same system as the ESB relay node Eb, and because the ESB relay node Eb already holds the route information of the communication route to the service Sc, the ESB relay node Eb inserts information indicating the ESB relay node Eb and a time stamp, as well as the route information of the communication route to the service Sc, into the received message. Further, the ESB relay node Eb changes the destination to the ESB relay node Ea and the message type to the route search control message (response) and returns the message to the interface through which the message has been received. More specifically, the ESB relay node Eb returns the route search control message (response) to the ESB relay node Ea (see (1) in FIG. 3).

The ESB relay node Ed performs a process similar to that performed by the ESB relay node Eb. More specifically, the ESB relay node Ed returns a route search control message (response) to the ESB relay node Ea (see (2) in FIG. 3).

Upon receiving the route search control messages (response) addressed to the ESB relay node Ea from the ESB relay nodes Eb and Ed, the ESB relay node Ea calculates transmission time periods of the messages for the communication routes via which the messages have been received based on the information included in the received messages, similarly to the example in which the proxy response is not involved. Based on the calculated transmission time periods, the ESB relay node Ea sets a route priority to each of the communication routes.

Accordingly, in the communication route selecting method according to the embodiment, the extent of transmission of the route search control messages is reduced and thus the load on the networks are reduced.

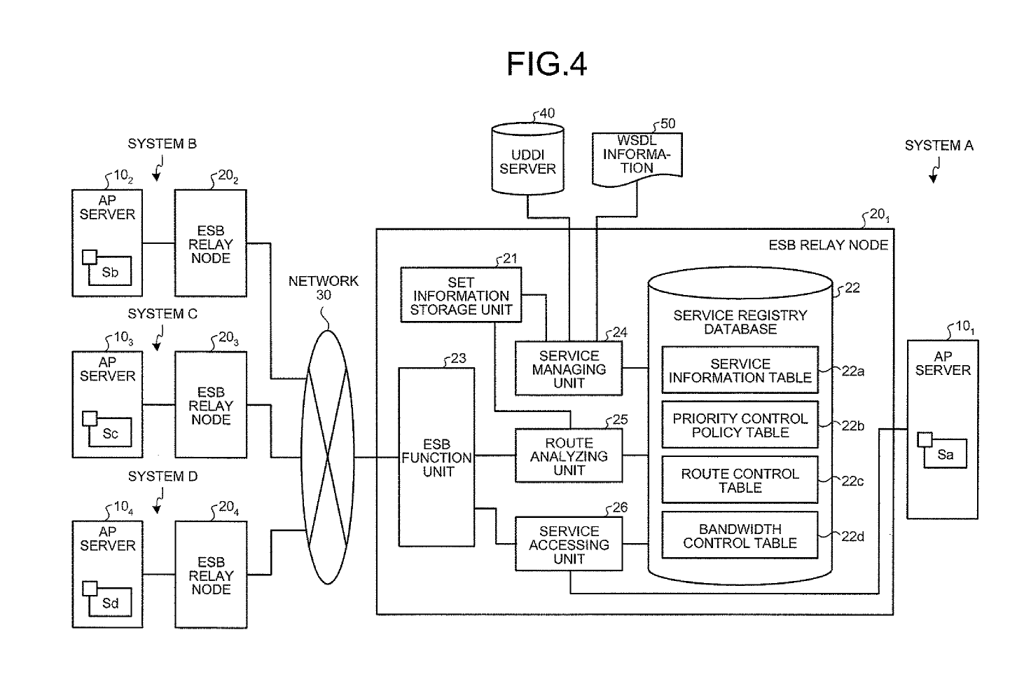

A configuration of the ESB relay node according to the embodiment will now be explained. FIG. 4 is a functional block diagram of the configuration of the ESB relay node according to the embodiment. FIG. 4 represents configurations of each of the systems A to D depicted in FIG. 1. Each of the systems A to D is connected via a network 30, and ESB relay nodes 20₁ to 20₄ respectively correspond to the ESB relay nodes Ea to Ed depicted in FIG. 1.

FIG. 4 also includes application (AP) servers 10₁ to 10₄, a universal description, discovery, and integration (UDDI) server 40, and WSDL information 50. The AP servers 10₁ to 10₄ execute applications that realize the services Sa to Sd. The UDDI server 40 provides UDDI service enabling a Web service made public on the Internet or a predetermined network to be searched or inquired. The WSDL information 50 represents other Web services.

Configurations of the ESB relay nodes 20₁ to 20₄ will now be explained. Because each of these ESB relay nodes has the same configuration, the ESB relay node 20₁ will be explained as an example.

The ESB relay node 20₁ is a communication apparatus having the ESB functions, and as depicted in FIG. 4, includes a set information storage unit 21, a service registry database 22, an ESB function unit 23, a service managing unit 24, a route analyzing unit 25, and a service accessing unit 26.

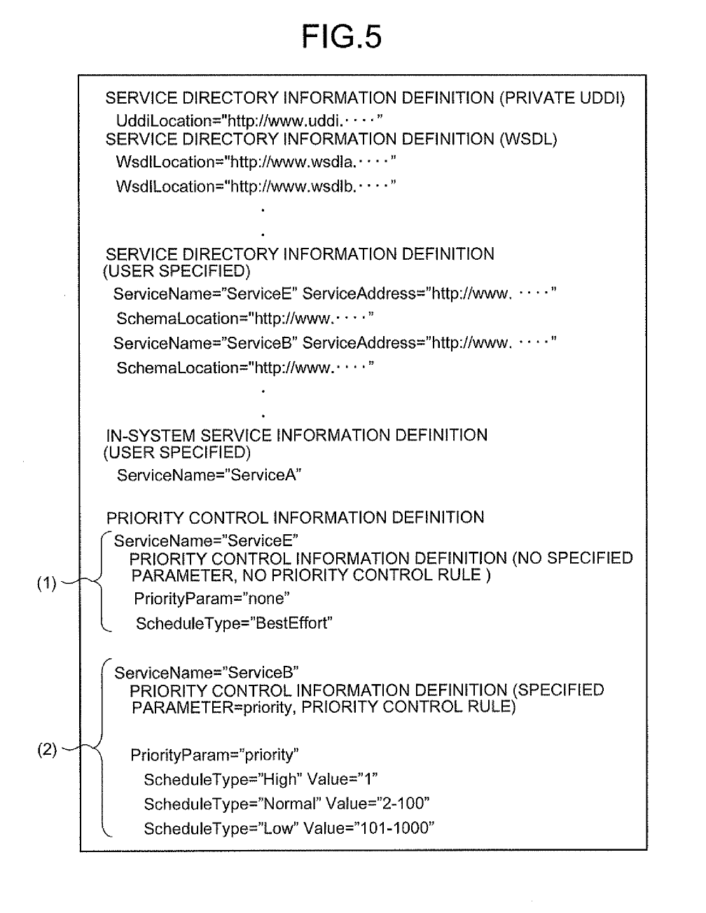

The set information storage unit 21 is a storage unit that stores therein set information including various set values for the route searching process. FIG. 5 is an example of the set information stored in the set information storage unit 21. As depicted in FIG. 5, the set information stored in the set information storage unit 21 includes a service directory information definition (private UDDI), a service directory information definition (WSDL), a service directory information definition (user specified), an in-system service information definition (user specified), and a priority control information definition. All of these pieces of the set information are specified by the user in advance. Each piece of the set information will now be explained one by one.

The service directory information definition (private UDDI) defines a location of the UDDI server 40 (UddiLocation). The service directory information definition (WSDL) defines a location where the WSDL information 50 for accessing various Web services is stored (WsdlLocation).

The service directory information definition (user specified) defines a name of a service (ServiceName) specified by the user, an address thereof (ServiceAddress) and a location where the XML schema is stored (SchemaLocation). The in-system service information definition (user specified) defines a name of a service (ServiceName) accommodated in the same system as the ESB relay node 20₁, more specifically, the service name of the service Sa.

By accessing various services based on the service directory information definition (private UDDI), the service directory information definition (WSDL), the service directory information definition (user specified) and the in-system service information definition (user specified), it is possible to collect service information on services accessible from the ESB relay node 20₁. The service information may include a service name and a service address (a URL indicating a location of the service).

The priority control information definition defines a service name (ServiceName), a priority parameter (PriorityParam), and a priority control type (ScheduleType) for each of these various services.

The priority parameter is information used as a keyword for extracting an item, based on which a priority of the message is determined, from a message exchanged between the services. The priority control type is information used for determining the message priority, according to a parameter value of the item extracted from the message based on the priority parameter.

To explain the priority parameter and the priority control type more specifically with reference to FIG. 5, section (1) in FIG. 5 represents the priority control information definition for the service Se (not depicted in FIG. 1), for example. A service name of “ServiceE”, a priority parameter of “none”, and a priority control type of “BestEffort” are set in this priority control information definition.

As depicted in this example, when the priority parameter is set as “none”, the message is transferred regardless of the priority thereof. When the priority control type is set as “BestEffort”, the message is transferred over a communication route having the shortest transmission time period regardless of the priority of the message.

Section (2), depicted in FIG. 5, represents the priority control information definition for the service Sb, for example. A service name of “ServiceB”, and a priority parameter of “priority” are set in this priority control information definition.

Further, three priorities of “High”, “Normal”, and “Low” are set for the priority control type and each of these priorities is associated with a range of parameter values extracted from a message based on a priority parameter.

More specifically, the priority “High” is associated with a range of parameter value “1”; the priority “Normal” is associated with a range of parameter values of “2-100” (representing a range from 2 to 100); and the priority “Low” is associated with a range of parameter values of “101-1000” (representing a range from 101 to 1000).

Based on the priority control information definition depicted in Section (2) in FIG. 5, a process of determining a message priority will be explained with respect to an example of “Google Sitemap”, one of the services provided by Google, Inc.

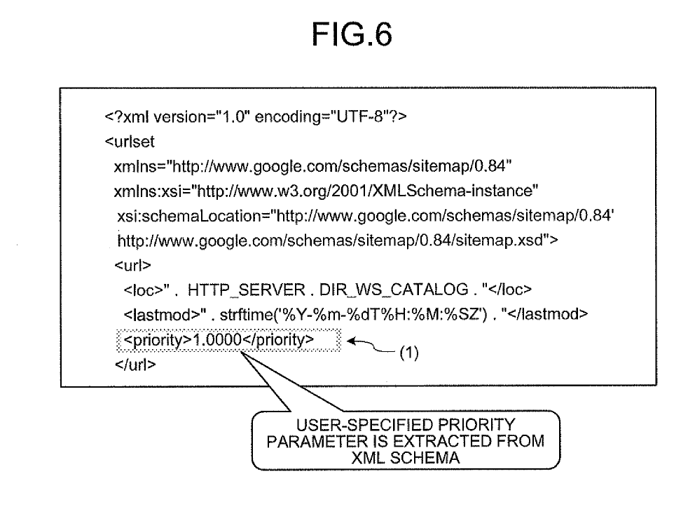

FIG. 6 is a diagram of an example of a Google Sitemap message. As depicted in Section (1) in FIG. 6, in a Google Sitemap message a “priority” tag for setting a priority of the URL written in the message is described.

For example, the information in the “priority” tag included in the message, (see Section (1) in FIG. 6) is extracted from the message based on “priority” of the priority parameter. Because the parameter value included in the extracted information is “1.000”, the priority is determined to be “High”.

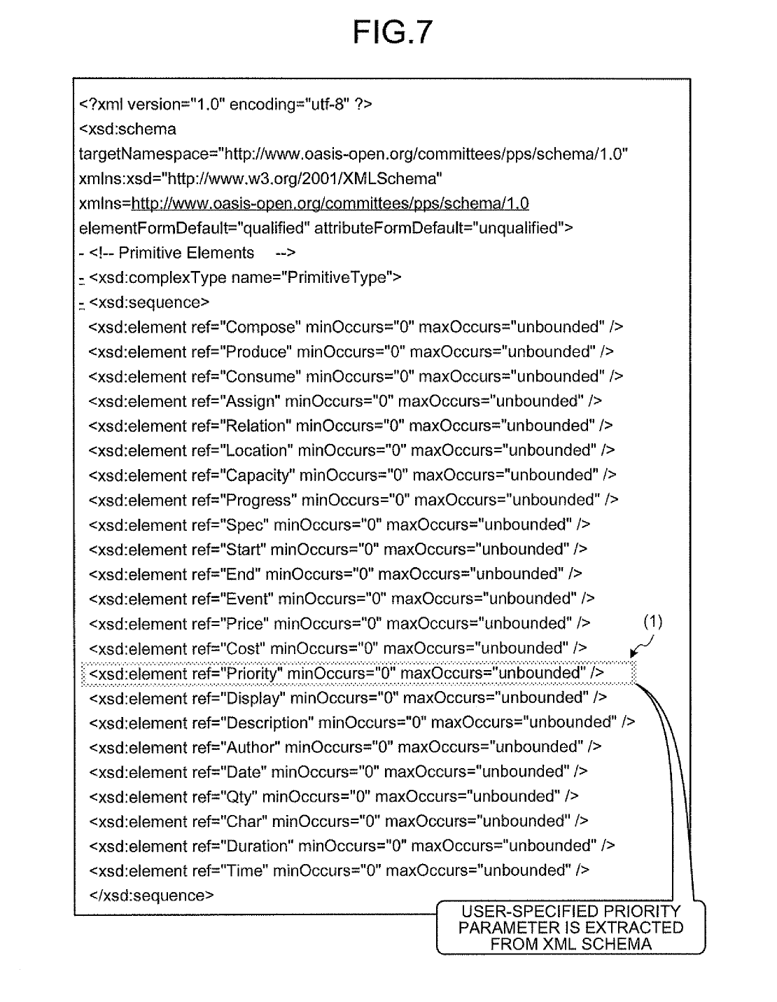

FIG. 7 is a diagram of an example of a message according to the OASIS PPS Part 1 “Core Element” specification. This message uses the XML schema defined by the OASIS Production Planning and Scheduling (PPS) Technical Committee of the Organization for the Advancement of Structured Information Standards (OASIS), an XML-related standardization organization.

As depicted in Section (1) in FIG. 7, in a message of the XML schema defined by the OASIS PPS, “Priority” is described as an item indicating a message priority, and a parameter value is set thereto (minOccurs=“0” and maxOccurs=“unbounded”, as depicted in FIG. 7). Therefore, it is possible to determine the priority for this message similarly, by setting the priority control type of the priority control information definition based on this parameter value.

Referring back to FIG. 4, the service registry database 22 is a database storing therein various tables including information for searching or selecting a communication route. The service registry database 22 includes a service information table 22a, a priority control policy table 22b, a route control table 22c, and a bandwidth control table 22d. Each of these tables will now be explained one by one.

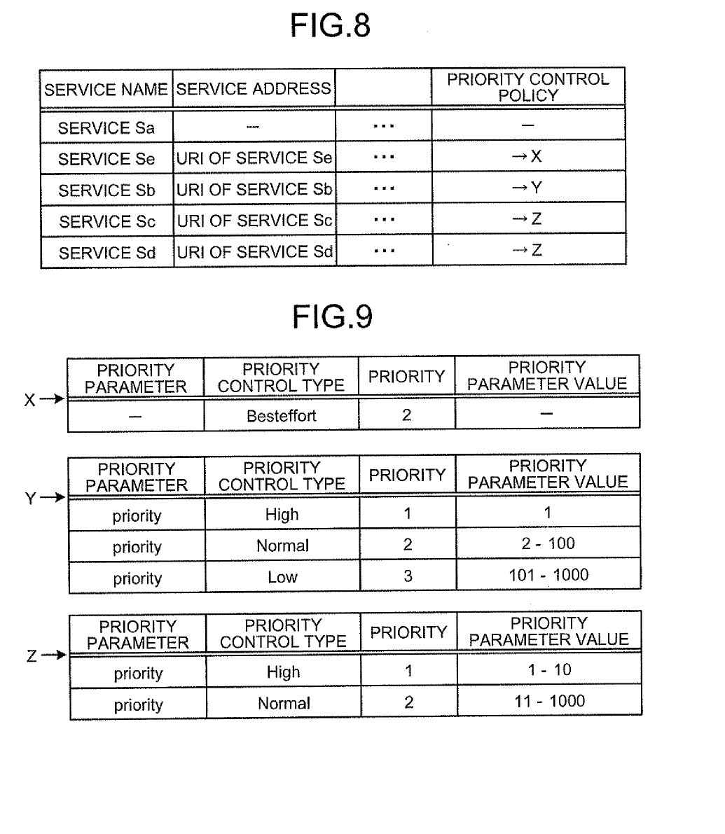

The service information table 22a stores therein service information for each of the services accessible from the ESB relay node 20₁. FIG. 8 is a diagram of an example of the service information stored in the service information table 22a. As depicted in FIG. 8, the service information includes, for example, a service name, a service address, and a priority control policy.

The service information is generated by the service managing unit 24 to be described later based on the set information stored in the set information storage unit 21. More specifically, for a service name and a service address, the service name and the service address included in the service information collected based on the service directory information definition (private UDDI), the service directory information definition (WSDL), the service directory information definition (user specified) and the in-system service information definition (user specified) included in the set information are set.

For the priority control policy, pointer information for associating each piece of the service information with priority control policy information stored in the priority control policy table 22b to be described later is set.

The priority control policy table 22b is a storage unit that stores therein priority control policy information including the priority parameter and the priority control type, for each combination of the priority control types. FIG. 9 is a diagram of an example of the priority control policy information stored in the priority control policy table 22b. As depicted in FIG. 9, the priority control policy information includes “priority parameter”, “priority control type”, “priority”, and “priority parameter value”.

The priority control policy information is generated by the service managing unit 24, to be described later, based on the set information stored in the set information storage unit 21. More specifically, the priority parameter, the priority control type, and the priority parameter value are generated for each combination of the priority control types (e.g., a combination of “High”, “Normal”, and “Low”, and a combination of “High” and “Normal”) based on the priority control information definition included in the set information for each of the services.

The generated priority control policy information is associated with the service information stored in the service information table 22a based on the priority control policy of the service information stored in the service information table 22a.

The route control table 22c stores therein route control information including information related to a communication route via which a message is transferred and a priority of the communication route, for each of the communication routes. The route control information stored in the route control table 22c is updated at any time based on the route search control message and the service information stored in the service information table 22a, every time the route analyzing unit 25, to be described later, performs the route searching process.

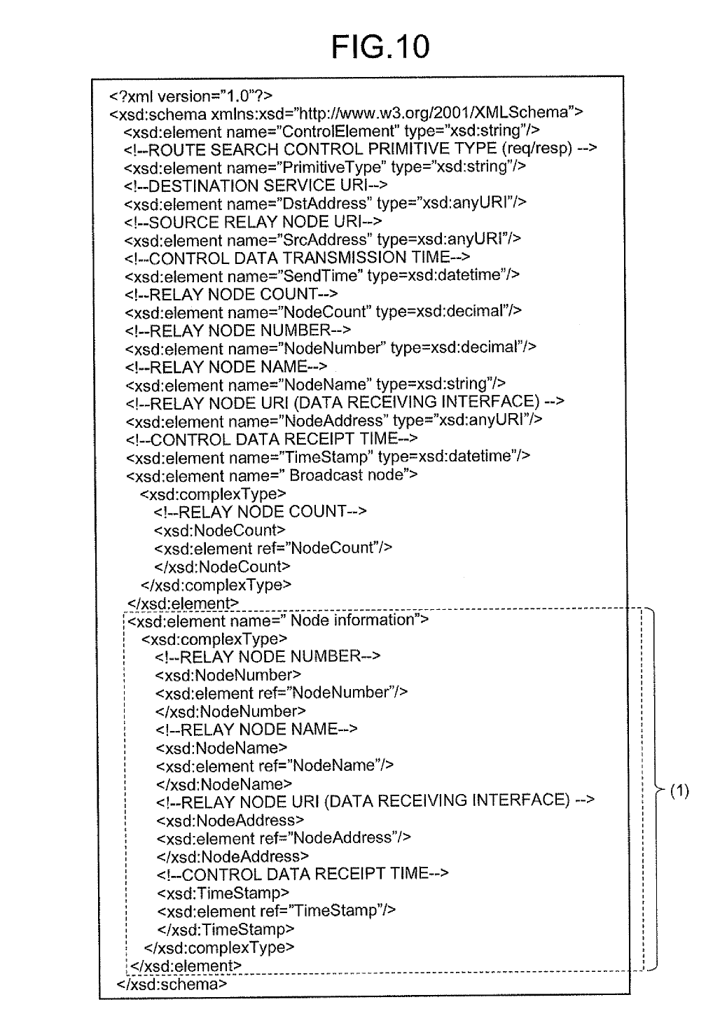

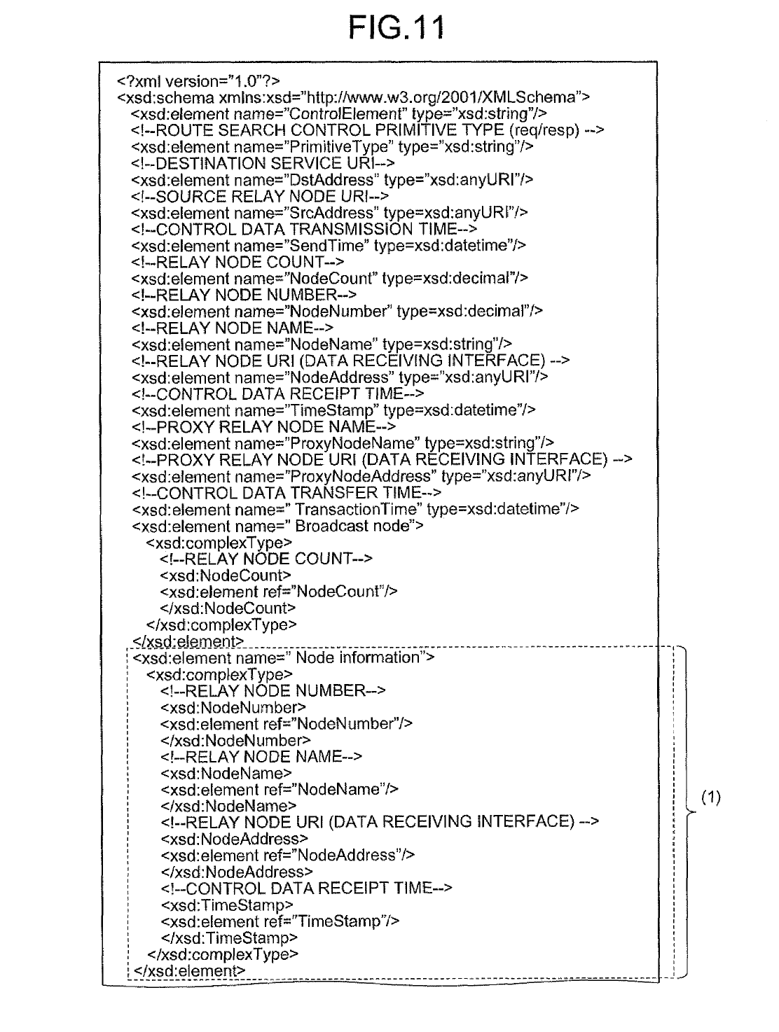

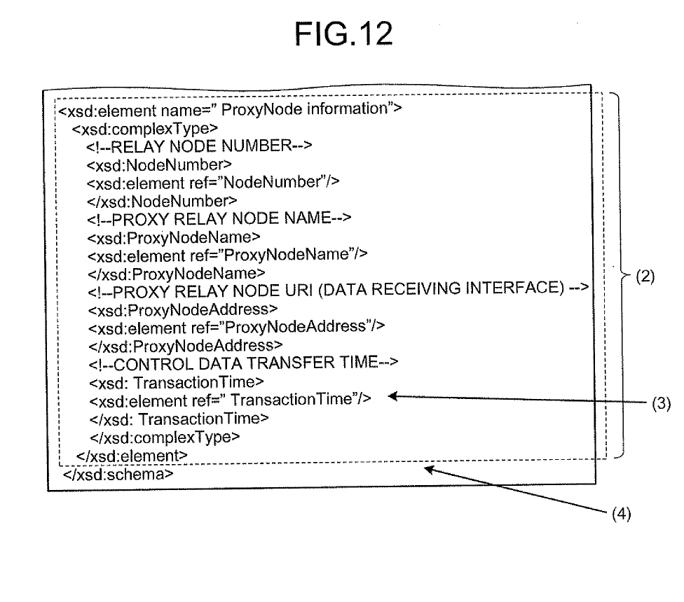

Before explaining the route control information more specifically, the route search control message used in the route searching process is explained. FIG. 10 is a diagram of an example of the route search control message used in the route searching process. FIGS. 11 and 12 are diagrams of examples of the route search control message when a proxy response is carried out during a message transfer.

As depicted in FIG. 10, the route search control message includes a route search control primitive type, a destination service URI, a source relay node URI, control data transmission time, a relay node count, a relay node number, a relay node name, a relay node URI, and control data receipt time. In a route search control message when a proxy response is carried out during the transfer further includes, as depicted in FIGS. 11 and 12, a proxy relay node name, a proxy relay node URI, and a control data transfer time. Each of these items included in the route search control message will now be explained one by one.

The route search control primitive type is an item by which information indicating whether the route search control message is a request message or a response message is set. The destination service URI is an item by which an address of a destination service is set.

The source relay node URI is an item by which the address of the ESB relay node sending the route search control message is set. The control data transmission time is an item by which the time when the ESB relay node transmits the route search control message is set. The relay node count is an item by which the number of ESB relay nodes present on a communication route to the destination service is set.

The relay node number is an item by which a serial number assigned to an ESB relay node present on a communication route to the destination service is set. The relay node name is an item by which the name of an ESB relay node present on a communication route to the destination service is set.

The relay node URI is an item by which the address of an ESB relay node present on a communication route to the destination service is set. The control data receipt time is an item by which a time at which an ESB relay node present on a communication route to a destination service receives the route search control message is set.

The relay node number, the relay node name, the relay node URI, and the control data receipt time are set in succession as many as the number of ESB relay nodes that transfer the route search control message (see Section (1) in FIG. 10 and Section (1) in FIG. 11).

The proxy relay node name is an item by which the name of an ESB relay node, when the ESB relay node present on a communication route to a destination service carries out a proxy response, is set. The proxy relay node URI is an item by which the address of the ESB relay node carrying out the proxy response is set.

The control data transfer time is an item by which the time period between a time point at which the ESB relay node carrying out the proxy response transmits the route search control message to the destination service and a time point at which the ESB relay node receives a response is set.

The proxy relay node name, the proxy relay node URI, and the control data transfer time are set only when a proxy response is carried out for the route search control message (see Section (2) in FIG. 12). For the control data transfer time, an average transmission time period for the corresponding service is set. This average transfer time period is included in the route control information described later (See Section (3) in FIG. 12).

Although omitted in FIG. 12, in Section (4) depicted in FIG. 12, the ESB relay node, responding as a proxy, sets information similar to that depicted in Section (1) in succession as many as the number of ESB relay nodes via which the route search control message is transferred from the ESB relay node responding as the proxy to the ESB relay node connected to the destination service of the route search control message.

In addition to these items, the priority parameter and the priority control type are inserted into the route search control message according to a destination service, when a plurality of route search control messages, each having a different priority, are sent over a communication route to measure a transmission time period corresponding to each of the message priorities.

The items included in the route search control message have been explained above. The route search control message is transferred periodically between the ESB relay nodes by the route searching process, and the route control information stored in the route control table 22c is updated at any time based on each of these items set in the route search control message.

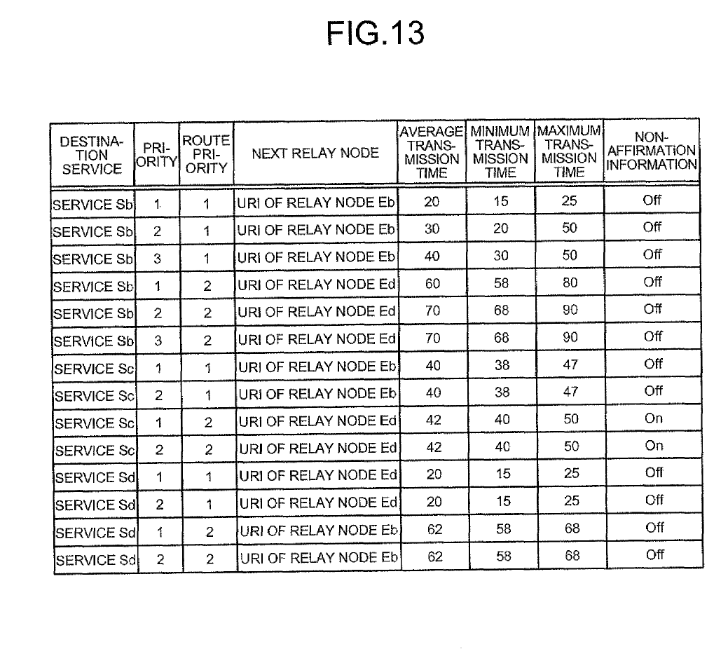

Going back to the explanation of the route control information, FIG. 13 is a diagram of an example of the route control information stored in the route control table 22c. The route control information includes “destination service”, “priority”, “route priority”, “next relay node”, “average transmission time”, “minimum transmission time”, “maximum transmission time”, and “non-affirmation information”, as depicted in FIG. 13.

For the destination service, the service name of the service information stored in the service information table 22a is set. For the priority, the priority stored in the priority control policy table 22b is set for each of the destination services. For the next relay node, the first relay node URI included in the route search control message (response) is set.

For the average transmission time, the minimum transmission time, and the maximum transmission time, the average, the minimum, and the maximum values of transmission time period are set respectively, which are calculated from the control data transmission time included in the route search control message (response), and the control data receipt time at the ESB relay node that receives the message lastly. When a proxy response is carried out for the route search control message, each transmission time period is calculated also based on the control data transfer time of the ESB relay node that carried out the proxy response.

To determine whether or not a communication route is available, the non-affirmation information is set as “off” for a communication route via which a route search control message (response) has been returned, and as “on” for a communication route via which a route control search message (response) could not be received after a predetermined time period has elapsed since the transmission.

For the route priority, a route priority that is determined based on the transmission time period is set, for each priority assigned to each of the destination services. The route priority is a serial number assigned to each communication route in an ascending order of the transmission time periods.

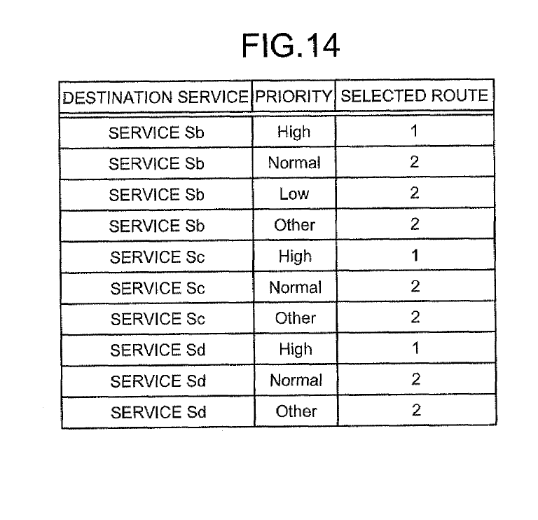

The bandwidth control table 22d is a storage unit that stores therein, for each of the services and the priorities assigned thereto, bandwidth control information indicating a communication route to be used for transmitting a message. FIG. 14 is a diagram of an example of the bandwidth control information stored in the bandwidth control table 22d. As depicted in FIG. 14, the bandwidth control information includes “destination service”, “priority”, and “selected route”.

The bandwidth control information stored in the bandwidth control table 22d is updated at any time every time the route analyzing unit 25 performs the route searching process, performed periodically, in the same manner as for the route control information, based on the service information stored in the service information table 22a, the priority control policy information stored in the priority control policy table 22b, and the route control information stored in the route control table 22c.

More specifically, for the destination service, a service name of the service information stored in the service information table 22a is set.

For the priority, for each destination service, a priority control type of the priority control policy information stored in the priority control policy table 22b is set. A priority type of “other” is set for each destination service as the priority for a situation in which a message not matching any of the priority control types of the priority control policy information (for example, a message without a priority parameter) is received.

For the selected route, for each of the destination services and the priorities assigned thereto, a route priority indicating the optimum communication route for transmitting a message is set. This route priority is set based on the priority control policy information stored in the priority control policy table 22b and the route priority in the route control information stored in the route control table 22c.

Setting of this selected route will now be explained more specifically with reference to FIG. 14. The bandwidth control information depicted in FIG. 14 is generated based on the priority control policy information depicted in FIG. 9 and the route control information depicted in FIG. 13.

For example, for the priority control policy information, three priorities for the service Sb, “1 (High)”, “2 (Normal)”, and “3 (Low)”, are set (see FIG. 9). For the route control information, two route priorities, “1” and “2” are set (see FIG. 13).

As depicted in FIG. 14, with respect to the bandwidth control information for the service Sb, the priority “High” is assigned with the route priority “1” having the shortest transmission time period as the selected route. The other priorities “Normal” and “Low” are assigned with the route priority “2” not having the shortest transmission time period as the selected route. To the “other”, the route priority “2” is also assigned as the selected route.

In other words, the setting of the selected route is determined based on the number of the priorities set in the priority control policy information, and the number of the route priorities set in the route control information. For example, if the number of the priorities is three and the number of the route priorities is two, the highest priority is assigned with the route priority “1”, and the other priorities (the second and the third highest priorities) are assigned with the route priority “2”. If the number of the priorities is four and the number of the route priorities is two, the highest and the second highest priorities are assigned with the route priority “1”, and the other priorities (the third and the fourth highest priorities) are assigned with the route priority “2”.

Referring back to FIG. 4, the ESB function unit 23 is a processing unit that controls transmission and reception of a message exchanged with other systems. The ESB function unit 23 also converts a protocol and a data format of a message transmitted to services in the other systems to a protocol or a data format processible by a Web service. The ESB function unit 23 has a function of an ESB generally used in the SOA.

The service managing unit 24 is a processing unit that generates the service information to be stored in the service information table 22a and the priority control policy information to be stored in the priority control policy table 22b, based on the set information stored in the set information storage unit 21. This priority control policy information generating process performed by the service managing unit 24 is hereinafter referred to as a “service information generating process”. Specific steps of this service information generating process will be described later in detail with reference to a flowchart.

The route analyzing unit 25 is a processing unit that performs the route searching process periodically using a route search control message, and updates the route control information stored in the route control table 22c and the bandwidth control information stored in the bandwidth control table 22d at any time based on a result of the route searching process. This bandwidth control information updating process performed by the route analyzing unit 25 is hereinafter referred to as a “bandwidth control information updating process”. Specific steps of the route searching process and the bandwidth control information updating process will be described later in detail with reference to flowcharts.

The service accessing unit 26 is a processing unit that determines the priority of a message upon receipt thereof, and selects a communication route for transmitting the message based on information of various tables stored in the service registry database 22. This communication route selecting process performed by the service accessing unit 26 is hereinafter referred to as a “message transfer route selecting process”. Specific steps of the message transfer route selecting process will be described later in detail with reference to a flowchart.

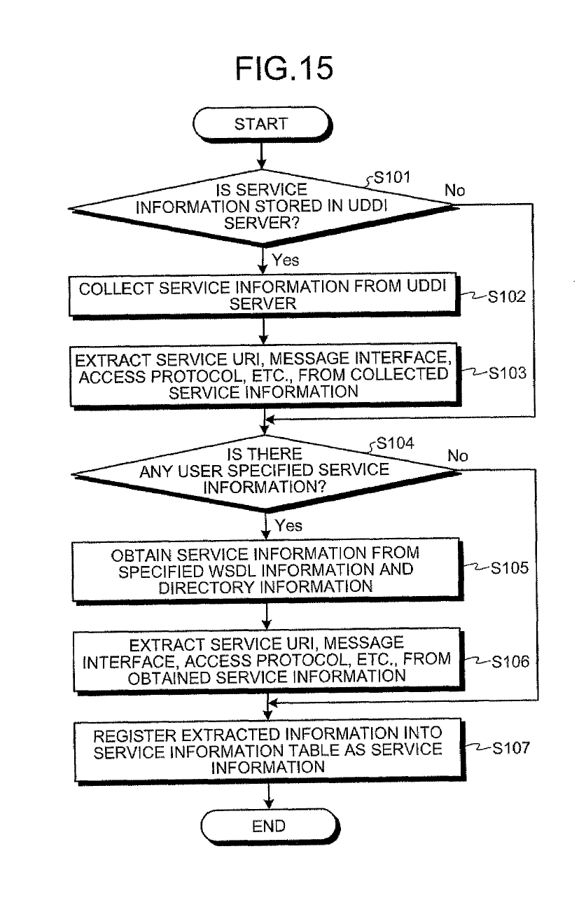

Each of the processes performed by each of the processing units included in the ESB relay node 20₁ according to this embodiment will now be explained. That is, steps of the processes performed by the service managing unit 24, the route analyzing unit 25, and the service accessing unit 26 will be explained in this order with reference to FIGS. 15 to 20.

The service information generating process performed by the service managing unit 24 will be explained. FIG. 15 is a flowchart indicating the steps of the service information generating process performed by the service managing unit 24. The service managing unit 24 performs the service information generating process described below at a predetermined timing or in a predetermined cycle, which may be specified by a user.

More specifically, as depicted in FIG. 15, the service managing unit 24 refers to the UDDI server 40 based on the set information stored in the set information storage unit 21 to determine whether the service information is in the UDDI server 40. If the service information is in the UDDI server 40 (YES at Step S101), the service managing unit 24 collects the service information from the UDDI server 40 (Step S102), and extracts, for example, a URI, a message interface, and an access protocol of the service from the collected service information (Step S103).

If the service information is not in the UDDI server 40 (NO at Step S101), the service managing unit 24 proceeds to the next step without collecting the service information from the UDDI server 40.

The service managing unit 24 then refers to the WSDL information 50 based on the set information stored in the set information storage unit 21 to determine if the service information specified by the user is in the WSDL information 50. If the service information specified by the user is in the WSDL information 50 (YES at Step S104) the service managing unit 24 obtains the service information from the specified WSDL information (service information) and the directory information (Step S105), and extracts, for example, a URI, a message interface, and an access protocol of the service from the obtained service information (Step S106).

If the service information specified by the user is not in the WSDL information 50 (NO at Step S104), the service managing unit 24 proceeds to the next step without collecting the service information from the WSDL information 50.

The service managing unit 24 registers the extracted information into the service information table 22a as the service information (Step S107), and ends the service information generating process.

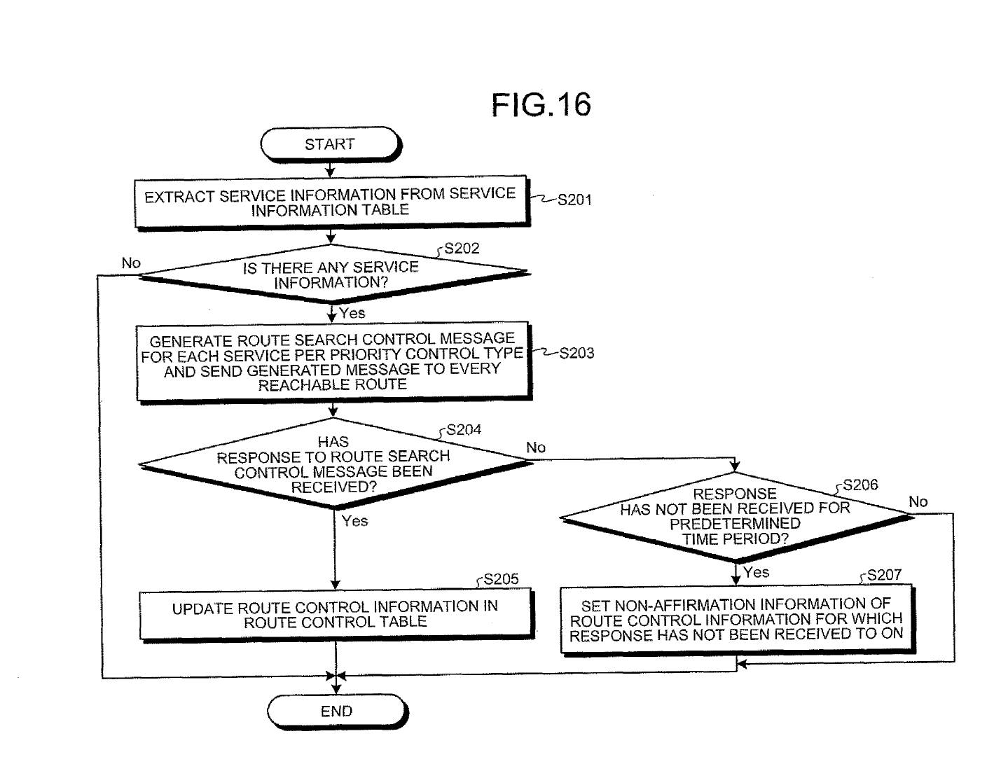

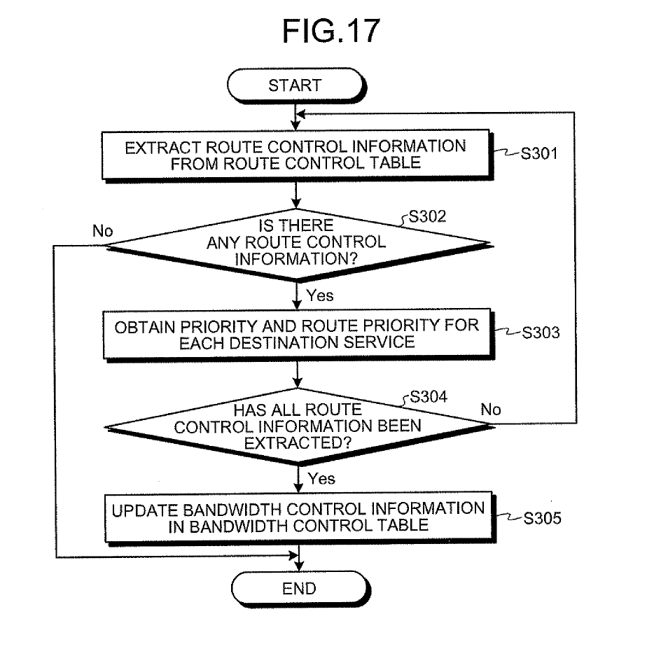

The route searching process and the bandwidth control information updating process, performed by the route analyzing unit 25, will now be explained. FIG. 16 is a flowchart indicating the steps of the route searching process performed by the route analyzing unit 25. FIG. 17 is a flowchart indicating the steps of the bandwidth control information updating process performed by the route analyzing unit 25.

The route analyzing unit 25 periodically performs the route searching process, described below, in a predetermined cycle. More specifically, as depicted in FIG. 16, the route analyzing unit 25 extracts the service information from the service information table 22a (Step S201).

If at least one service information is extracted (YES at Step S202), the route analyzing unit 25 generates route search control messages, one for each of the priority control types included in the set information stored in the set information storage unit 21, with respect to each of the services of all of the extracted service information, and sends the route search control messages, each generated for each of the priority control types, to every communication route that is reachable to the services (Step S203).

If there is no service information in the service information table 22a (NO at Step S202), the route analyzing unit 25 ends the route searching process without sending a route search control message.

If the route analyzing unit 25 receives a response to the route search control message via the ESB function unit 23 (Step S204), the route analyzing unit 25 updates the route control information stored in the route control table 22c based on the received route search control message and the service information stored in the service information table 22a (Step S205), and ends the route searching process.

If the route analyzing unit 25 does not receive a response to the route search control message after a predetermined time period elapses (Step S206), the route analyzing unit 25 sets the non-affirmation information in the route control information for the communication route via which a response has not been received, from among the route control information stored in the route control table 22c, to “ON” (Step S207), and ends the route searching process.

The route analyzing unit 25 also periodically performs the bandwidth control information updating process described below, in a predetermined cycle. More specifically, as depicted in FIG. 17, the route analyzing unit 25 extracts one of the route control information from the route control table 22c (Step S301).

If there is route control information (YES at Step S302), the route analyzing unit 25 obtains the priority and the route priority for each destination service, from the extracted route control information (Step S303).

The route analyzing unit 25 then determines whether all of the route control information, stored in the route control table 22c, has been extracted. If all of the route control information has not been extracted yet (NO at Step S304), the route analyzing unit 25 analyzes another piece of the route control information, and performs the same steps.

If all of the route control information has been extracted (YES at Step S304), the route analyzing unit 25 updates the bandwidth control information stored in the bandwidth control table 22d based on the extracted priority and route priority (Step S305).

If there is no route control information in the route control table 22c at Step S302 (NO at Step S302), the route analyzing unit 25 ends the bandwidth control information updating process without obtaining any priority and route priority.

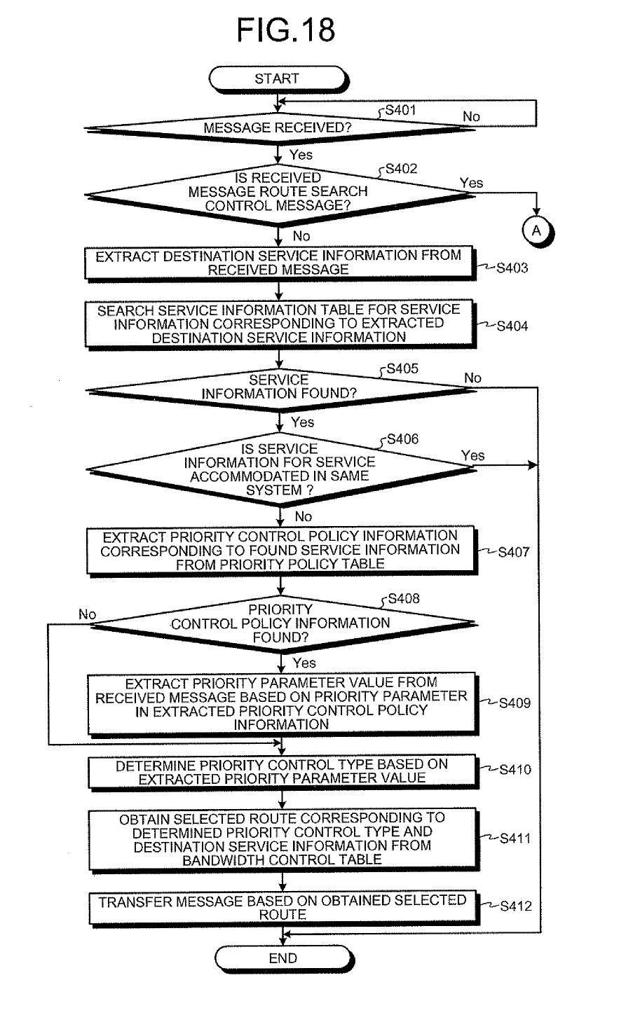

The message transfer route selecting process performed by the service accessing unit 26 will now be explained. FIGS. 18, 19, and 20 are flowcharts indicating the steps of the message transfer route selecting process performed by the service accessing unit 26.

As depicted in FIG. 18, if a message is received via the ESB function unit 23 (YES at Step S401), the service accessing unit 26 checks whether the received message is a route search control message. If it is not a route search control message (NO at Step S402), the service accessing unit 26 extracts the information on the destination service from the received message (Step S403).

The service accessing unit 26 then searches the service information table 22a for the service information corresponding to the extracted information on the destination service (Step S404). If no corresponding service information is found (NO at Step S405), the service accessing unit 26 ends the message transfer route selecting process.

If the corresponding service information is found (YES at Step S405), the service accessing unit 26 checks whether the service information is service information of the service (that is, the service Sa) accommodated in the same system as the node including the service accessing unit 26.

If the service information is for the service accommodated in the same system as the node including the service accessing unit 26 (YES at Step S406), the service accessing unit 26 ends the message transfer route selecting process.

If the service information is not for the service accommodated in the same system as the node including the service accessing unit 26 (NO at Step S406), the service accessing unit 26 extracts the priority control policy information corresponding to the service information found from the service information table 22a, from the priority control policy table 22b (Step S407).

If the service accessing unit 26 finds the corresponding priority control policy information in the priority control policy table 22b (YES at Step S408), the service accessing unit 26 extracts the priority parameter value from the received message based on the priority parameter included in the extracted priority control policy information (Step S409).

If the service accessing unit 26 does not find the corresponding priority control policy information in the priority control policy table 22b (NO at Step S408), the service accessing unit 26 proceeds to the next step without extracting the priority parameter value from the received message.

The service accessing unit 26 then determines the priority control type based on the extracted priority parameter value (Step S410). If the service accessing unit 26 does not find the corresponding priority control policy information in the priority control policy table 22b, or does not find any priority control type corresponding to the extracted priority parameter value, the service accessing unit 26 determines that the priority control type is “other”.

After determining the priority control type, the service accessing unit 26 refers to the bandwidth control information stored in the bandwidth control table 22d, and obtains the selected route corresponding to the determined priority control type and the destination service extracted from the received message (Step S411).

The service accessing unit 26 then transfers the received message based on the obtained selected route (Step S412), and ends the message transfer route selecting process.

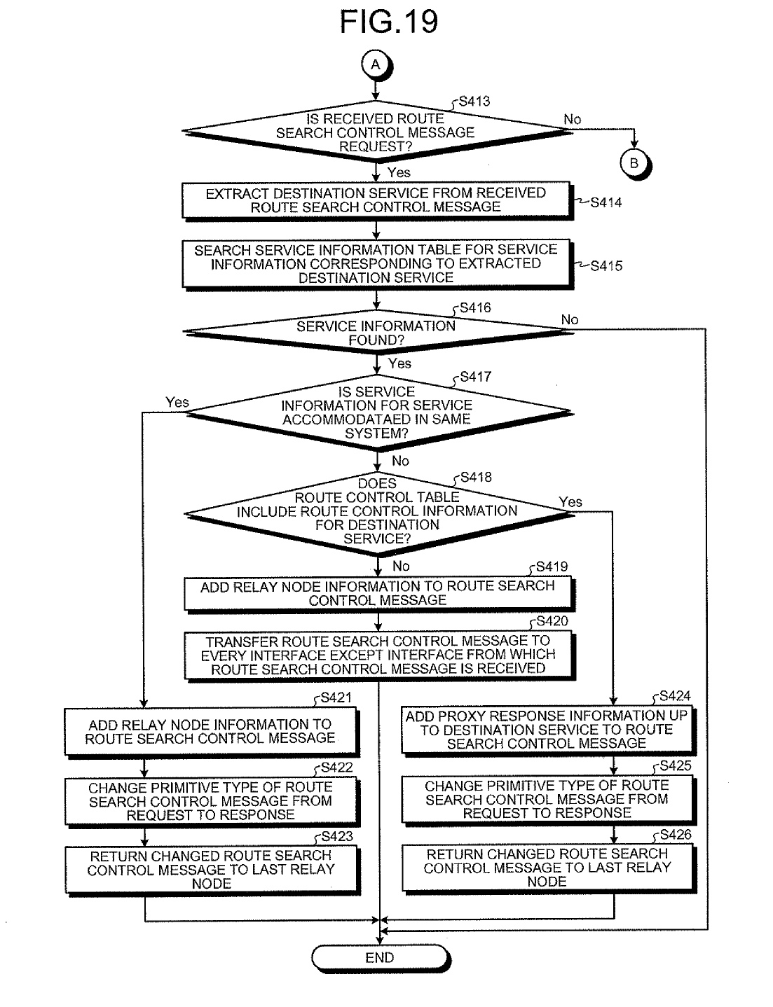

If the received message is a route search control message at Step S402 (YES at Step S402), the service accessing unit 26 checks whether the received route search control message is a request, as depicted in FIG. 19. If the received route search control message is a request (YES at Step S413), the service accessing unit 26 extracts the information on the destination service from the received route search control message (Step S414).

The service accessing unit 26 then searches the service information table 22a for the service information corresponding to the extracted information on the destination service (Step S415). If no corresponding information is found (NO at Step S416), the message transfer route selecting process is ended.

If the service accessing unit 26 finds the corresponding service information (YES at Step S416), the service accessing unit 26 determines whether the service information is that of the service accommodated in the same service as the node including the service accessing unit 26 (in other words, that of the service Sa).

If the service information is not that of the service accommodated in the same service as the node including the service accessing unit 26 (NO at Step S417), the service accessing unit 26 determines whether there is route control information, for the communication route to the destination service, in the route control table 22c.

If there is no corresponding route control information (NO at Step S418), the service accessing unit 26 adds relay node information (information of Section (1) in FIGS. 10 and 11) to the received route search control message (Step S419). The service accessing unit 26 then transfers the route search control message to which the relay node information has bee added to all interfaces excluding the one via which the route search control message has been received (Step S420), and ends the message transfer route selecting process.

At Step S417, if it is determined that the service information is that of the service accommodated in the same service as the node including the service accessing unit 26 (YES at Step S417), the service accessing unit 26 adds the relay node information to the received route search control message (Step S421), changes the primitive type of the route search control message (the route search control primitive type) from “request” to “response” (Step S422). The service accessing unit 26 then returns the changed route search control message to the last relay node through which the route search control message has been received (Step S423), and ends the message transfer route selecting process.

At Step S418, if the route control information up to the destination service is in the route control table 22c (YES at Step S418), the service accessing unit 26 adds the proxy response information up to the destination service (the information of Section (2) in FIG. 12) to the received route search control message (Step S424). The service accessing unit 26 further changes the primitive type of the route search control message (route search control primitive type) from “request” to “response” (Step S425) returns the changed route search control message to the last relay node through which the route search control message has been received (Step S426), and ends the message transfer route selecting process.

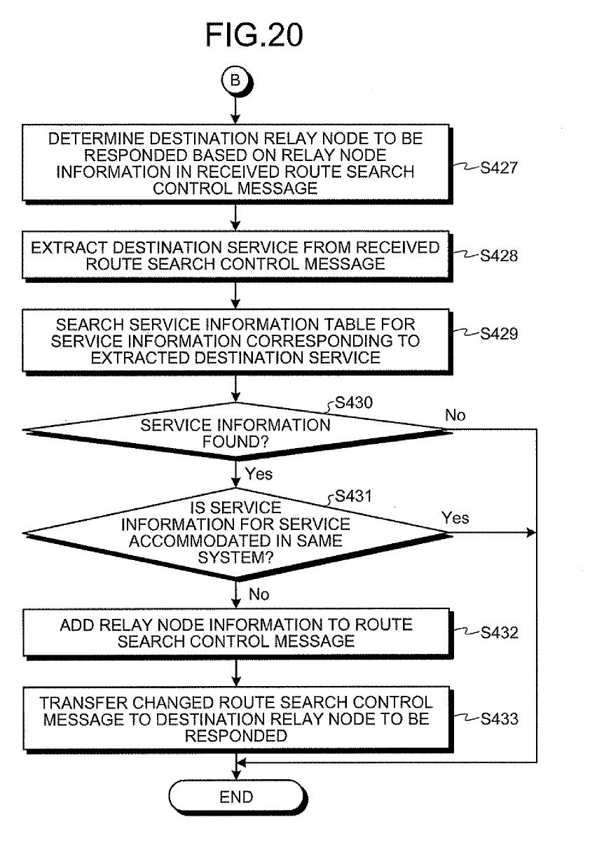

At Step S413, if the received route search control message is not a request, that is, if the message is a response (NO at Step S413), the service accessing unit 26 determines the ESB relay node to respond to, that is, the ESB relay node through which the route search control message upon request has been received, based on the relay node information included in the received route search control message (Step S427), as depicted in FIG. 20.

The service accessing unit 26 then extracts the information on the destination service from the received route search control message (Step S428), and searches the service information table 22a for the service information corresponding to the extracted information on the destination service (Step S429).

If no corresponding service information is found (NO at Step S430), the service accessing unit 26 ends the message transfer route selecting process.

If corresponding service information is found (YES at Step S430), the service accessing unit 26 further determines if the service information is of a service accommodated in the same system as the node including the service accessing unit 26 (that is, if the service information is of the service Sa).

If the service information is the service information of the service accommodated in the same system as the node including the service accessing unit 26 (YES at Step S431) the service accessing unit 26 ends the message transfer route selecting process.

If the service information is not of the service information of the service accommodated in the same system as the node including the service accessing unit 26 (NO at Step S431), the service accessing unit 26 adds the relay node information to the received route search control message (Step S432), returns the changed route search control message to an ESB relay node to be responded to (Step S433), and ends the message transfer route selecting process.

As described above, according to the embodiment, the route analyzing unit 25 exchanges the route search control messages over communication routes to measure the time period taken to transmit the message over each of these communication routes, and to determine the priority of each of the communication routes based on the measured transmission time periods. Furthermore, if a priority has been set for a message exchanged between the communication apparatuses, the service accessing unit 26 selects the communication route to be used for transmitting a message from a plurality of communication routes based on the priority of the message and the priority determined by the route analyzing unit 25. Therefore, it is possible to select the optimum communication route in accordance with the priority of the message.

Furthermore, according to the embodiment, the route analyzing unit 25 stores the route control information including the measured transmission time period for each of the communication routes in the route control table 22c. Moreover, the service accessing unit 26 determines, upon receiving a route search control message from another ESB relay node, whether the route control information for the communication route to the service set as a destination of the route search control message is included in the route control information stored in the route control table 22c. If it is included, the service accessing unit 26 returns the route search control message including the transmission time period to the source ESB relay node. Therefore, it is possible to reduce the transmission range of the message for measuring the transmission time period and thus reduce the load on the network.

Furthermore, according to the embodiment, the route analyzing unit 25 exchanges the route search control message for which the priority has been set over communication routes to measure the transmission time period per communication route and message priority. Therefore, it is possible to select the optimum communication route according to the message priority.

In the example described in this embodiment, the present invention is applied to a distributed system with four systems connected in a ring configuration. However, the present invention is not limited to such a configuration, and may be applied to a configuration with less or greater than four systems, or to a configuration where each of the systems is connected in a mesh configuration or any other network topology.

This embodiment has been described with respect to the ESB relay node. However, the configuration of the ESB relay node may be realized by software to obtain a communication route selecting program having the same functions. Thus, a computer, executing such a communication route selecting program, will now be explained.

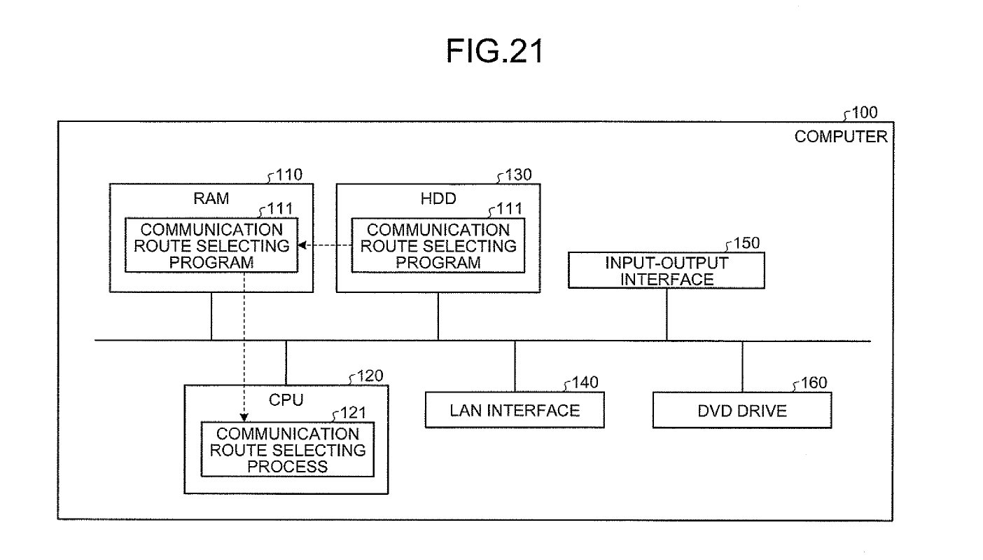

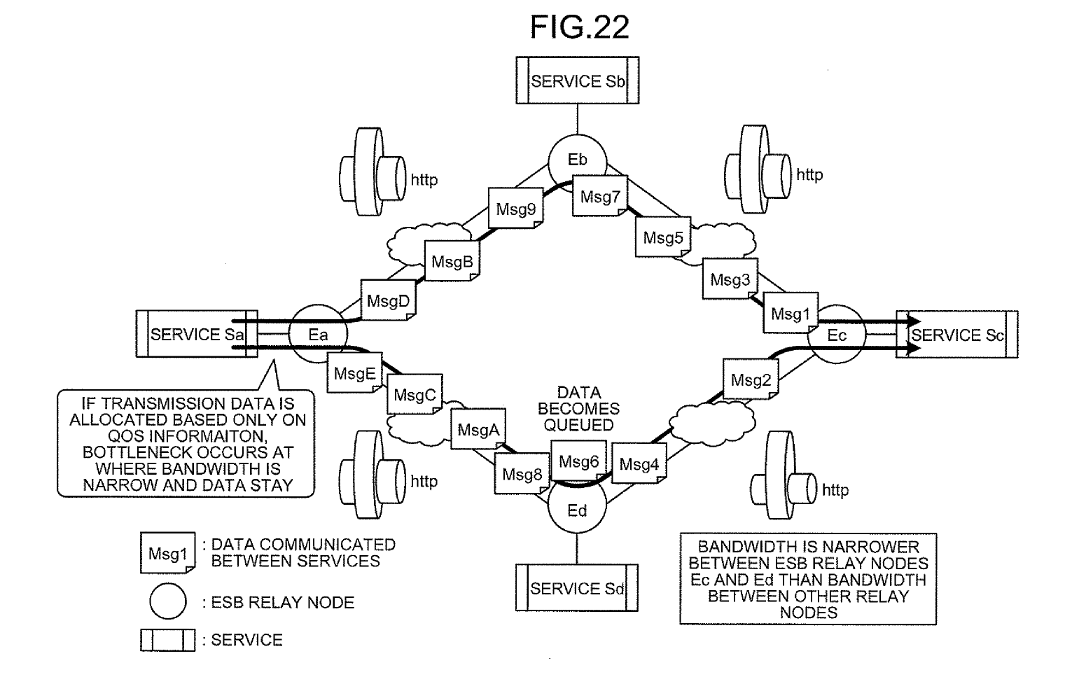

FIG. 21 is a functional block diagram of a configuration of the computer executing the communication route selecting program according to the embodiment. As depicted in FIG. 21, a computer 100 includes a random access memory (PAM) 110, a central processing unit (CPU) 120, a hard disk drive (HDD) 130, a local area network (LAN) interface 140, an input-output interface 150, and a digital versatile disk (DVD) drive 160.

The RAM 110 is a memory configured to store therein computer programs and results during execution of the computer programs. The CPU 120 is a central processing unit configured to read and executes the computer programs from the RAM 110.

The HDD 130 is a disk unit configured to store therein computer programs and data. The LAN interface 140 is an interface configured to connect the computer 100 to another computer via a LAN.

The input-output interface 150 is an interface configured to connect an input unit, such as a mouse or a keyboard, and a display unit. The DVD drive 160 is an apparatus configured to read from and write to a DVD.

A communication route selecting program 111 executed on the computer 100 is stored in a DVD, and read from the DVD by the DVD drive 160 to be installed onto the computer 100.

Alternatively, the communication route selecting program 111 may be stored in a database on another computer connected via the LAN interface 140, for example, and may be read out from the database to be installed onto the computer 100.

The installed communication route selecting program 111 is stored in the HDD 130, read onto the RAM 110, and executed by the CPU 120 as a communication route selecting process 121.

All or a part of these processes explained to be performed automatically in the embodiment may be performed manually and all or a part of the processes explained to be performed manually may be performed automatically by a known method.

In addition, the processing and control steps, specific names, information including various data and parameters described herein and in the drawings may be modified in any way unless specified otherwise.

Each of the structural elements of the apparatuses in the drawings has been illustrated functionally and conceptionally, and may be physically structured differently from the drawings. In other words, specific modes of distribution or integration of each apparatus are not limited to those depicted in the drawings, and all or any part thereof may be distributed or integrated functionally or physically in any unit depending on various loads or usage.

For example, the functions of the ESB relay node according to the embodiment may be implemented by the AP server.

Furthermore, all or a part of the processing functions performed in each of the apparatuses may be also realized by a CPU and a computer program analyzed and executed by the CPU, or as hardware based on wired logic.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A computer readable storage medium containing instructions that, when executed by a computer, cause the computer to perform:
measuring a transmission time period taken to transmit a message for each of a plurality of communication routes by exchanging a control message via the plurality of communication routes;
determining a priority of each of the plurality of communication routes based on the measured transmission time period; and
if a priority has been set to a message to be exchanged between communication apparatuses connected via the plurality of communication routes, selecting one of the plurality of communication routes, as a route to transmit the message based on the set priority and the determined priority.

2. The computer readable storage medium according to claim 1, further containing instructions that, when executed by the computer, cause the computer to perform:
storing route information including the measured transmission time period in a storage unit for each of the plurality of communication routes;
determining, upon receiving a control message from another communication apparatus, whether route information for a communication route to a communication apparatus set as a destination of the received control message is included in the stored route information; and
if the route information for the communication route to the destination is determined to be included in the stored route information, returning a control message including the route information, to the another communication apparatus.

3. The computer readable storage medium according to claim 1, wherein a priority is set for the control message exchanged in the measuring, and the transmission time period is measured for each of the communication routes and each priority set to the exchanged control message.

4. A method comprising:
measuring a transmission time period taken to transmit a message for each of a plurality of communication routes by exchanging a control message via the plurality of communication routes;
determining a priority of each of the plurality of communication routes based on the measured transmission time period; and
if a priority has been set to a message to be exchanged between communication apparatuses connected via the plurality of communication routes, selecting one of the plurality of communication routes, as a route to transmit the message based on the set priority and the determined priority.

5. The method according to claim 4, further comprising:
storing route information including the measured transmission time period in a storage unit for each of the plurality of communication routes;
determining, upon receiving a control message from another communication apparatus, whether route information for a communication route to a communication apparatus set as a destination of the received control message is included in the stored route information; and
if the route information for the communication route to the destination is determined to be included in the stored route information, returning a control message including the route information, to the another communication apparatus.

6. The method according to claim 4, wherein a priority is set for the control message exchanged in the measuring, and the transmission time period is measured for each of the communication routes and each priority set to the exchanged control message.

7. An apparatus comprising:
a measuring unit that measures a transmission time period taken to transmit a message for each of a plurality of communication routes by exchanging a control message via the plurality of communication routes;
a determining unit that determines a priority of each of the plurality of communication routes based on the measured transmission time period; and
a selecting unit that, if a priority has been set to a message to be exchanged between communication apparatuses connected via the plurality of communication routes, selects one of the plurality of communication routes, as a route to transmit the message based on the set priority and the determined priority.

8. The apparatus according to claim 7, further comprising:
a storing unit that stores route information including the measured transmission time period in a storage device for each of the plurality of communication routes; and
a proxy response unit that determines, upon receiving a control message from another communication apparatus, whether route information for a communication route to a communication apparatus set as a destination of the received control message is included in the stored route information, and if the route information for the communication route to the destination is determined to be included in the stored route information, returns a control message including the route information, to the another communication apparatus.

9. The apparatus according to claim 7, wherein a priority is set for the control message exchanged by the measuring unit, and the measuring unit measures the transmission time period for each of the communication routes and each priority set to the exchanged control message.
